(19) United States
(12) Patent Application Publication
(10) Pub. No.: US 2017/0004077 A1
(43) Pub. Date: Jan. 5, 2017

(54) Method of collecting a garbage block in a solid state disk

(71) Applicant: QUANTA STORAGE INC., Taoyuan City (TW)

(72) Inventors: An-Te Liu, Taoyuan City (TW); Tzu-Wei Fang, Taoyuan City (TW); Yi-Long Hsiao, Taoyuan City (TW)

(21) Appl. No.: 15/131,040

(22) Filed: Apr. 18, 2016

(30) Foreign Application Priority Data
Jul. 2, 2015 (CN) 201510379564.5

(51) Int. Cl. G06F 12/02

(52) U.S. Cl. CPC G06F 12/0253; G06F 2212/7205

(57) ABSTRACT

A method of collecting a garbage block includes determining if a process of collecting the garbage block is being executed when a write command is received, copying effective pages of the garbage block to a target block in the spare area, terminating the process of collecting the garbage block, and writing data according to the write command

### BACKGROUND OF THE INVENTION

1. Field of the Invention

The present invention presents a method of collecting a garbage block in a solid state disk, more particularly, a method of collecting a garbage block in a solid state disk wherein the process of collecting the garbage block is interrupted when writing data in the solid state disk.

2. Description of the Prior Art

A solid state disk (SSD) is a memory formed using a plurality of non-volatile flash memory. When a conventional solid state disk receives a command to access memory, a mapping table is used to convert the logical page address (LPA) of the accessed data to a corresponding physical page address (PPA) and transmits the accessed data to the flash memory. A flash memory has a data area and a spare area. Each area comprises a plurality of blocks. Each block comprises a plurality of physical pages. A physical page is taken as units when performing erase cycle. The flash memory reads the data in the physical address according to a data block of the data area. After the solid state disk transmits the update data to the host, the solid state disk selects a spare block in the spare area and writes the update data into the spare block to form a new data block in the data area and update the mapping table. Afterwards, the logical page address of the data in the original data block is registered to be discarded and used again during the collecting of a garbage block in solid state disk.

FIG. 1 illustrates a flowchart of a method of collecting a garbage block in solid state disk according to prior art. The method of the prior art includes the following steps:

Step P1: the solid state disk of the prior art receiving a write command;

Step P2: determining if a program for collecting a garbage block is being executed; if yes, go to step P3, if no, go to step P6;

Step P3: selecting a block in the spare area to be a target block;

Step P4: copying effective data in the garbage block, moving the effective data to a physical page in the target block, and labeling the effective data as ineffective data;

Step P5: erasing all data in the garbage block; and

Step P6: executing the write data command.

Therefore, the solid state disk of the prior art is able to rearrange the effective data in the garbage block in the target block. In this way, the block in the data area may be emptied and may await its turn to be used as a spare block.

However, when the solid state disk of the prior art is executing the method of collecting a garbage block, one garbage block is used as a unit during recycling. After the effective data are copied to the target block, all of the data in the garbage block are erased to complete the recycling of a garbage block. When writing data, the solid state disk must wait for collecting a garbage block to be completed before writing of the data may begin. Thus, the efficiency of writing of data is affected. The more effective data there is in the garbage block, the longer time it would take for the process of collecting the garbage block to finish. Thus, the writing of the data in the solid state disk is delayed due to the collecting of the garbage block and effectively decreases the efficiency of accessing operation of the solid state disk. Therefore, there are problems that may occur during the collecting of a garbage block that needs to be addressed.

### SUMMARY OF THE INVENTION

An objective of the present invention is to present a method of collecting a garbage block of a solid state disk. After a write command is received, a portion of effective pages in the garbage block is moved to a target block. The process of collecting the garbage block is terminated before writing data. Thus, the efficiency of writing data is increased.

Another objective of the present invention is to present a method of collecting a garbage block of a solid state disk. A predetermined threshold corresponding to the number of spare blocks is set. When the number of the spare blocks in the spare area is less than the predetermined threshold, a process of collecting the garbage block is completed before writing data to avoid affecting the operation the solid state disk.

To achieve the abovementioned objectives, a method of collecting a garbage block of a solid state disk may comprise writing data according to a write command if a process of collecting of a garbage block is not being performed when the write command is received. If the process of collecting of the garbage block is being performed when the write command is received, performing partial collecting of the garbage block by copying a portion of effective pages of the garbage block to a target block in a spare area, terminating the program for collecting the garbage block, and writing data according to the write command. In this way, the efficiency of writing data is increased.

The garbage block is divided in groups. Each of the groups has a portion of effective pages of the garbage block. The effective pages are grouped according to relation of data stored in the effective pages. After writing the data according to the write command, it is determined if the garbage block still has effective pages and writing of the data is ended. When the garbage block still has the effective pages, the program for collecting of the garbage block is reinitialized and collecting of the garbage block is completed.

Another method of collecting a garbage block of a solid state disk may comprise writing data according to a write command if a process of collecting of a garbage block is not being performed when the write command is received. If the process of collecting of the garbage block is being performed when the write command is received, determining if the number of spare blocks in a spare area is greater than a predetermined threshold, performing partial collecting of the garbage block by copying a portion of effective pages of the garbage block to a spare block in a spare area, terminating the program for collecting the garbage block, writing data according to the write command, and ending writing of the data. In this way, the efficiency of writing data is increased.

The predetermined threshold is the minimum number of spare blocks in the spare area for the solid state disk to effectively operate. When the number of the spare blocks in the spare area is less than a predetermined threshold, collecting of the garbage block is completed. The effective pages of the garbage block are copied to a spare block of the spare area. The effective pages are then registered as ineffective pages. And, the garbage block is recycled to be a spare block in the spare area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a method of collecting a garbage block in solid state disk according to prior art.

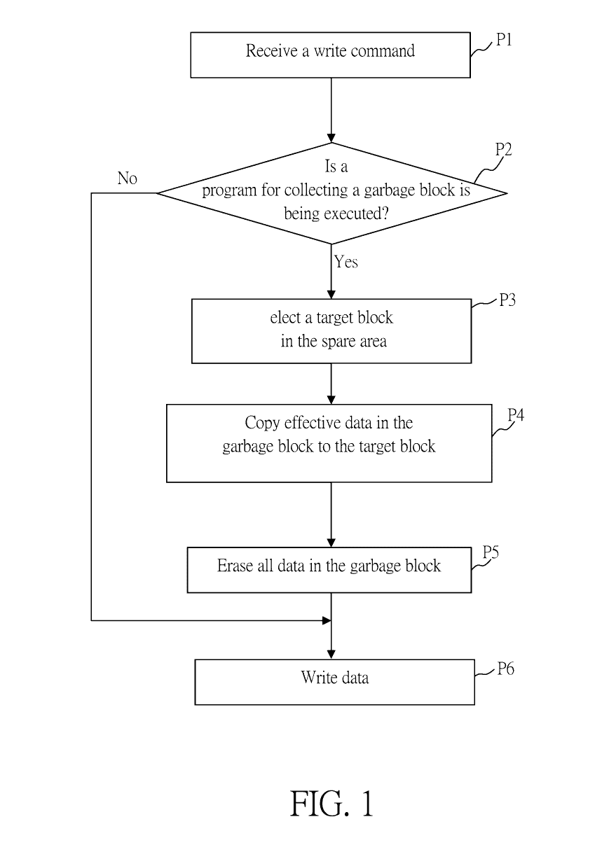

FIG. 2 illustrates a structure of a solid state disk according to an embodiment of the present invention.

FIGS. 3A and 3B illustrate diagrams of the solid state disk when performing collecting of a garbage block according to a first embodiment.

FIG. 4 illustrates a flowchart of a method of collecting a garbage block of a solid state disk according to a first embodiment of the present invention.

FIGS. 5A to 5C illustrate diagrams of the solid state disk when performing collecting of a garbage block according to a second embodiment.

FIG. 6 illustrates a flowchart of a method of collecting a garbage block of a solid state disk according to a second embodiment of the present invention.

FIG. 7 illustrates a flowchart of a method of collecting a garbage block of a solid state disk according to a third embodiment of the present invention.

### DETAILED DESCRIPTION

To achieve the objective of the present invention, preferred embodiments of the present invention are described in the following paragraphs together with some illustrations.

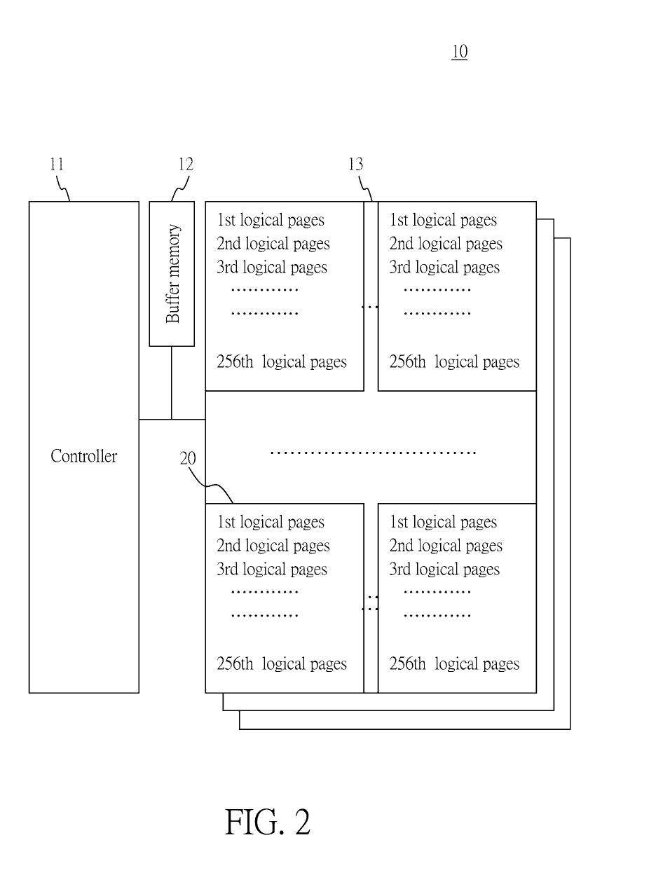

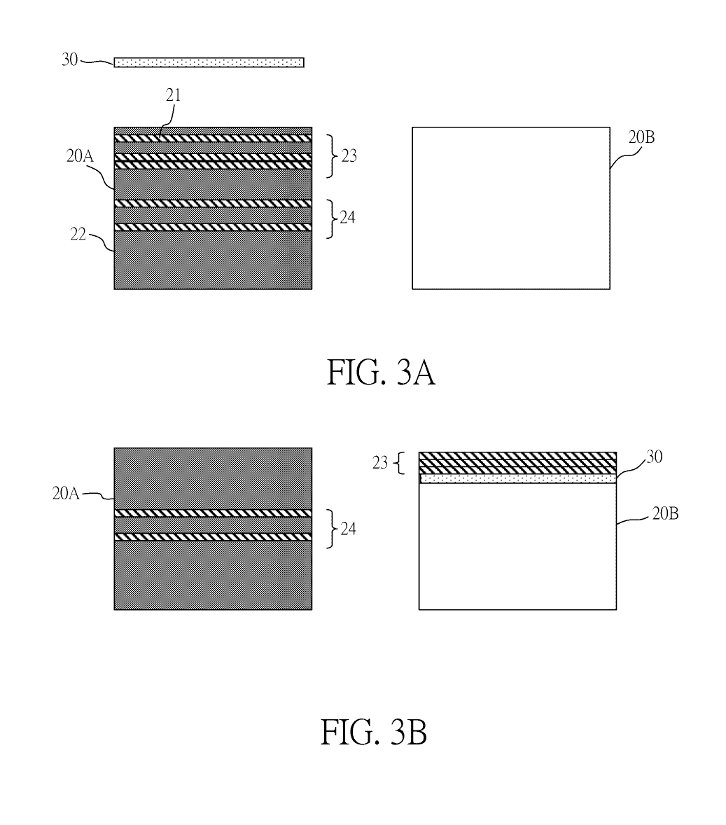

FIG. 2 illustrates a structure of a solid state disk according to an embodiment of the present invention. FIGS. 3A and 3B illustrate diagrams of the solid state disk when performing collecting of a garbage block according to a first embodiment. The solid state disk 10 comprises a controller 11, a buffer memory 12 and a flash memory 13. The controller 11 may be configured to cooperate with the buffer memory 12. The buffer memory 12 may be used to store control parameters controlling the plurality of flash memories 13 used to store data during accessing of data. Each of the flash memory 13 may comprise a plurality of blocks 20. Each of the plurality of blocks 20 may comprise 256 physical pages to store 256 logical page data.

When the solid state disk receives a write command from the host during the collecting of a garbage block, the garbage block collected may, for example, be the block 20A in FIG. 3A. The block 20A may comprise of a plurality of effective pages and a plurality of ineffective pages 22. And, an empty block 20B in the spare area may be selected as the target block. The effective pages 21 in the block 20A may be divided into a number of groups according to the correlation of data. Example of the grouping may be shown in the first group of effective pages 23 and the second group of effective pages of FIG. 3A. As shown in FIG. 3B, when performing the partial collecting of garbage block on the block 20A, the first group of effective pages 23 may be considered as the partially collected garbage block. The first group of effective pages 23 may be copied to the block 20B and the block 20B may be registered into the mapping table. The first group of effective pages 23 may then be erased from the mapping table. Afterward, the process of collecting the garbage block may be terminated. And, the data 30 may be written into the block 20B set to be the target block. The block 20A may be left for the garbage block collected in the next execution of the process of collecting the garbage block. Thus, the speed of writing data is increased.

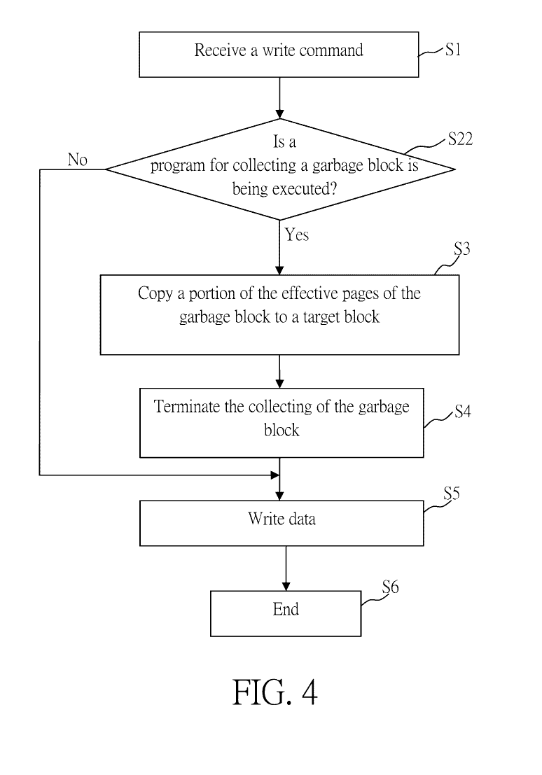

FIG. 4 illustrates a flowchart of a method of collecting a garbage block of a solid state disk according to a first embodiment of the present invention. The method may include, but is not limited to, the following steps:

Step S1: the solid state disk of the prior art receiving a write command;

Step S2: determining if a program for collecting a garbage block is being executed; if yes, go to step S3, if no, go to step S5;

Step S3: performing partial collecting of garbage block by copying a portion of the effective pages of the garbage block to a target block in the spare area;

Step S4: terminating the collecting of the garbage block;

Step S5: executing the write command; and

Step S6: ending writing of the data.

Therefore, according to above mention process, when a write command is received during the collecting of the garbage block of the solid state disk, partial collecting of garbage block may be used to terminate the collecting of garbage block as quickly as possible without damaging the data in the garbage block. Thus, the speed of executing the write command is increased to improve the efficiency of the solid state disk.

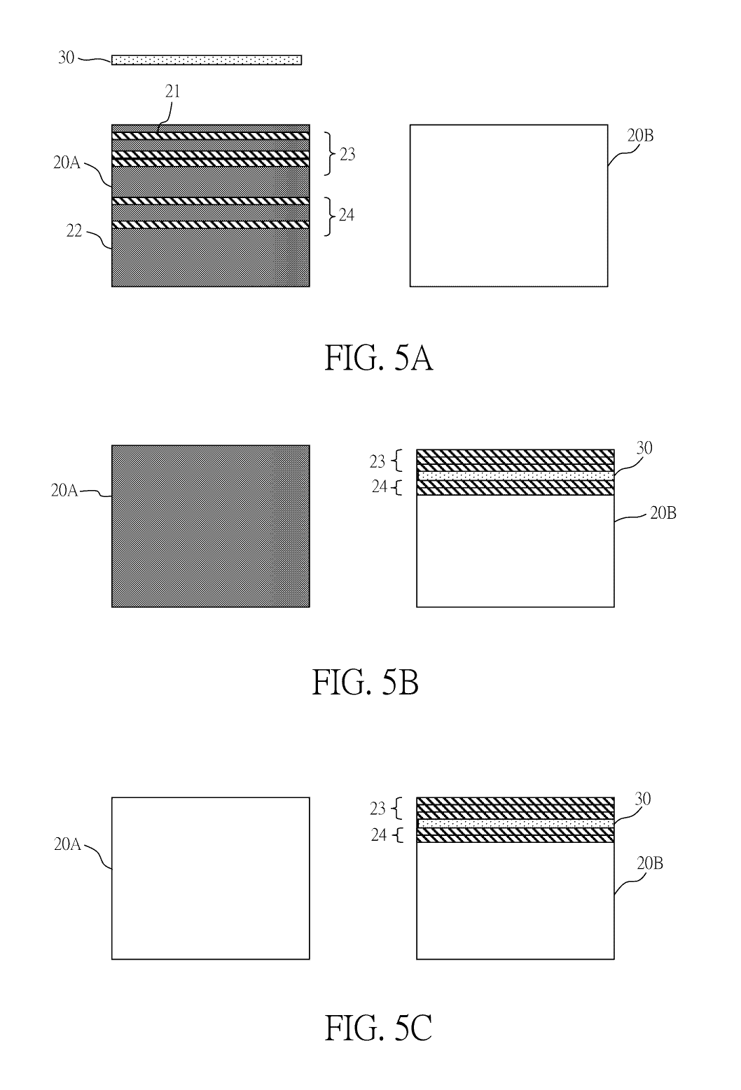

FIGS. 5A to 5C illustrate diagrams of the solid state disk when performing collecting of the garbage block according to a second embodiment. The solid state disk used when performing the process of collecting garbage block presented in the second embodiment is similar to that presented in the first embodiment. Thus, the structure of the solid state disk is no longer described for brevity. In the second embodiment, when the solid state disk in FIG. 5A receives a write command from the host, the garbage block being collected may be the block 20A. The block 20A may comprise a plurality of effective pages 21 and a plurality of ineffective pages 22. An empty block 20B in the spare area may be selected as the target block. The effective pages 21 in block 20A may be divided into groups such as a first group of effective pages 23 and a second group of effective pages 24. As shown in FIG. 5A, when the process of collecting the garbage block is performed in block 20A, the group of effective pages 23 may be copied to the block 20B and the block 20B may be registered into the mapping table. The first group of effective pages 23 may then be erased from the mapping table. Afterward, the process of collecting garbage block may be terminated. And, the data 30 may be written into the block 20B set to be the target block. After the processing of the data 30, the process of collecting garbage block may be initiated again. The remaining effective pages 21 such as the second group of effective pages 24 may be copied to the block 20B to complete the collecting of garbage block. Afterwards, block 20A may be recycled and reclassified under the spare area to form a new spare block.

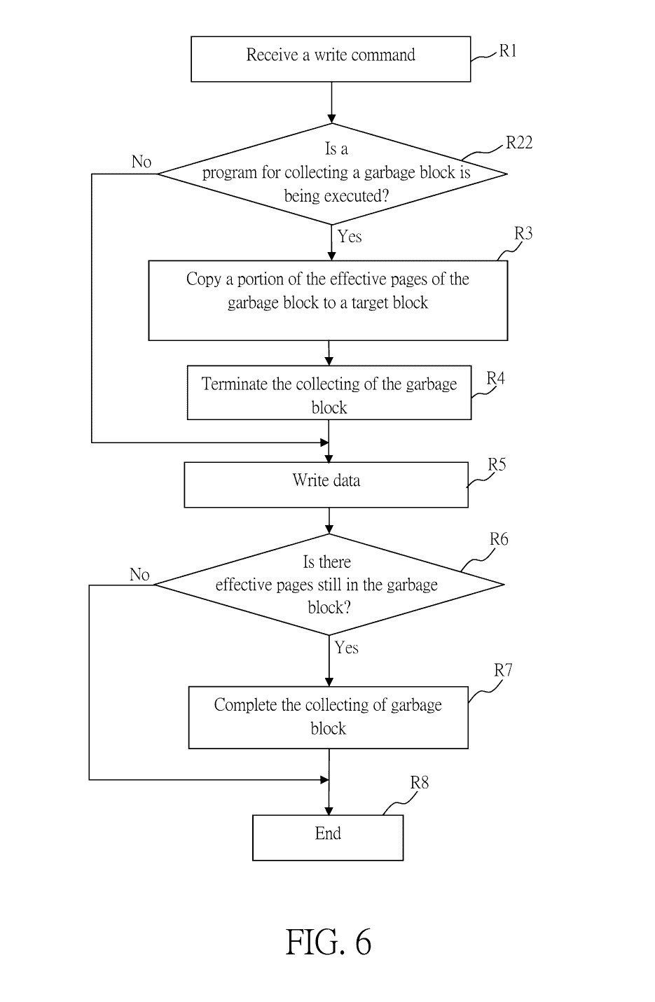

FIG. 6 illustrates a flowchart of a method of collecting a garbage block of a solid state disk according to a second embodiment of the present invention. The method may include, but is not limited to, the following steps:

Step R1: the solid state disk of the prior art receiving a write command;

Step R2: determining if a program for collecting a garbage block is being executed; if yes, go to step R3, if no, go to step R5;

Step R3: performing partial collecting of the garbage block by copying a portion of the effective pages of the garbage block to a target block in the spare area;

Step R4: terminating the collecting of the garbage block;

Step R5: executing the write command;

Step R6: determining if there are effective pages still in the garbage block; if yes, go to step R7; if no, go to step R8;

Step R7: if there are still effective pages in the garbage block, completing the collecting of garbage block; and

Step R8: ending writing of the data.

Therefore, according to above mention process, when a write command is received during the collecting of the garbage block of the solid state disk, the process of collecting the garbage block may be temporarily terminated to increase the speed of writing data. After the writing of data is finished, the process of collecting garbage block may be resumed to complete the collecting of the garbage block. In this way, the efficiency of writing data is increased. At the same time, the completion of the process of collecting garbage block may not be affected.

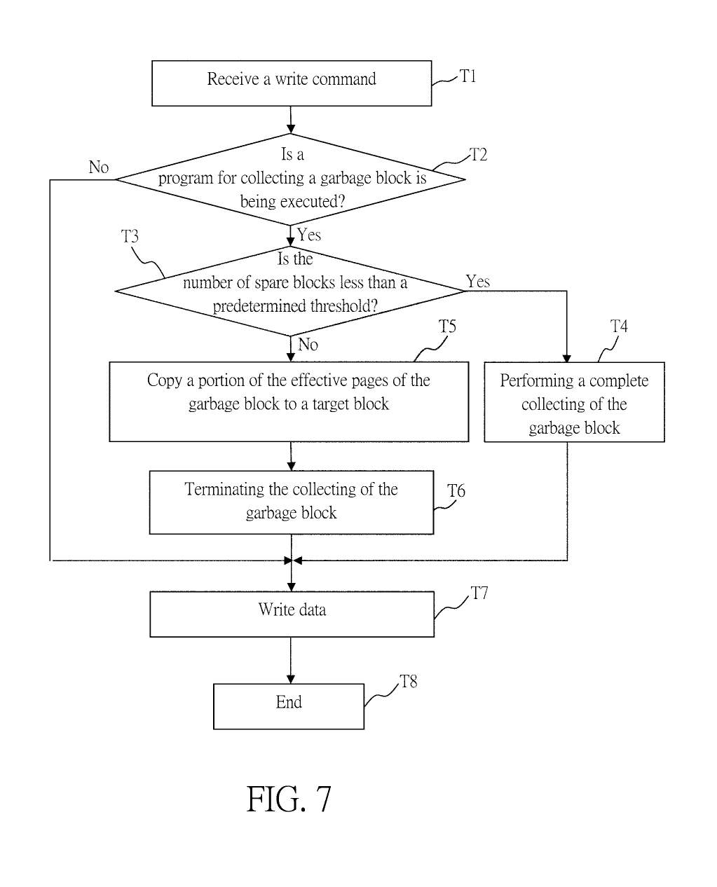

FIG. 7 illustrates a flowchart of a method of collecting a garbage block of a solid state disk according to a third embodiment of the present invention. The process of collecting the garbage block is performed to increase the number of spare blocks in the solid state disk. In this way, the stored data may be distributed in the solid state disk and increase the life span of the solid state disk. The method of collecting garbage block in the first embodiment implements a forced stop on the collecting of garbage block to execute the write command first. In this way, the collecting of the garbage block may not be completed. Thus, the number of spare blocks may decrease until the number of spare block may no longer be enough and cause a problem in the operation of the solid state disk. To avoid affecting the operation of the solid state disk, the method of collecting a garbage block according to the third embodiment may include, but is not limited to, the following steps:

Step T1: the solid state disk of the prior art receiving a write command;

Step T2: determining if a program for collecting a garbage block is being executed; if yes, go to step T3, if no, go to step T7;

Step T3: determining if the number of spare blocks in the spare area is less than a predetermined threshold; if yes, go to step T4; if no, go to step T5;

Step T4: performing a complete collecting of the garbage block; proceed to step T7;

Step T5: performing partial collecting of garbage block by copying a portion of the effective pages of the garbage block to a target block in the spare area;

Step T6: terminating the collecting of the garbage block;

Step T7: executing the write command; and

Step T8: ending writing of the data.

Therefore, according to above mentioned process, in the method of collecting the garbage block in the third embodiment of the present invention, a predetermined threshold for the number of spare blocks available during the operation of the solid state disk may be set. When a write command is received during the collecting of the garbage block of the solid state disk, the collecting of the garbage block may be completed first if the number of spare blocks is less than the predetermined threshold. After the collecting of the garbage block is completed, the write command may then be executed. In this way, the operation of the solid state disk may not be affected.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of collecting a garbage block of a solid state disk, the method comprising:
receiving a write command;
determining if a program for collecting the garbage block is being executed;
performing partial collecting of the garbage block;
terminating the program for collecting the garbage block;
writing data according to the write command; and
ending writing of the data.

2. The method of claim 1, wherein performing partial collecting of the garbage block is copying a portion of effective pages of the garbage block to a target block in a spare area.

3. The method of claim 2, wherein the garbage block is divided in groups, each of the groups has a portion of effective pages of the garbage block, and the effective pages are grouped according to relation of data stored in the effective pages.

4. The method of claim 1, wherein writing the data according to the write command is performed when the program for collecting the garbage block is not being executed.

5. The method of claim 1, further comprising:
after writing the data according to the write command, determining if the garbage block has effective pages.

6. The method of claim 5, further comprising:
if the garbage block has the effective pages, initializing collecting of the garbage block, and completing collecting of the garbage block.

7. A method of collecting a garbage block of a solid state disk, the method comprising:
receiving a write command;
determining if a program for collecting the garbage block is being executed;
determining if a number of spare blocks in a spare area is greater than a predetermined threshold;
performing partial collecting of the garbage block;
terminating the program for collecting the garbage block;
writing data according to the write command; and
ending writing of the data.

8. The method of claim 7, wherein writing the data according to the write command is performed when the program for collecting the garbage block is not being executed.

9. The method of claim 7, further comprising:
when the number of the spare blocks in the spare area is less than the predetermined threshold, completing collecting of the garbage block before writing the data according to the write command.

10. The method of claim 9, wherein completing collecting of the garbage block comprises copying effective pages of the garbage block to a spare block of the spare area, registering the effective pages as ineffective pages, and recycling the garbage block to be a new spare block in the spare area.

11. The method of claim 7, wherein the predetermined threshold is a minimum number of spare blocks in the spare area during operation of the solid state disk.
